(19) United States
(12) Patent Application Publication
(10) Pub. No.: US 2013/0055121 A1
(43) Pub. Date: Feb. 28, 2013

(54) APPARATUS AND METHOD FOR DISPLAYING SPLASH SCREEN

(71) Applicants: Woongsuk CHO, Seoul (KR); Kunhoon Baik, Seoul (KR); Wonyoung Choi, Suwon-si (KR); Wonguk Jeong, Suwon-si (KR)

(72) Inventors: Woongsuk CHO, Seoul (KR); Kunhoon Baik, Seoul (KR); Wonyoung Choi, Suwon-si (KR); Wonguk Jeong, Suwon-si (KR)

(73) Assignee: Samsung Electronics Co., Ltd., Gyeonggi-do (KR)

(21) Appl. No.: 13/596,855

(22) Filed: Aug. 28, 2012

(30) Foreign Application Priority Data
Aug. 29, 2011 (KR) 10-2011-0086366

(51) Int. Cl. G09G 5/00; G06F 3/048

(52) U.S. Cl. 715/764; 345/619

(57) ABSTRACT

A method and apparatus are provided for displaying a splash screen in a screen display apparatus. It is determined whether editable splash screen information corresponding to an application program is stored in the screen display apparatus, when a command to execute the application program is received at the screen display apparatus. The splash screen is configured according to the editable splash screen information when the editable splash screen information is stored in the screen display apparatus. The splash screen configured by the editable splash screen information is displayed on the screen display apparatus.

### PRIORITY

This application claims priority under 35 U.S.C. §119(a) to an application filed in the Korean Intellectual Property Office on Aug. 29, 2011, and assigned Serial No. 10-2011-0086366, the contents of which are incorporated herein by reference.

### BACKGROUND OF THE INVENTION

1. Field of the Invention

The present invention relates generally to an apparatus and method for displaying a splash screen, and more particularly, to a method for displaying a splash screen according to editable splash screen information corresponding to an execution-requested application program, and an apparatus for displaying the splash screen according to the method.

2. Description of the Related Art

A splash screen refers to a screen having an image or other information that is shown to user during a loading process when executing an application program. Some examples of the splash screen include a logo of an application program or an introduction page of a website, for example.

The splash screen is used to notify the user that a process is in progress when executing an application program having a long loading time, due to its large size, for example. Generally, the splash screen displays a designated image, however, it sometimes displays a progress bar showing the progress state, or a simple text.

Methods for displaying a splash screen include the displaying of designated images. Therefore, there is no flexibility in displaying the splash screen based on a change of the theme or the screen resolution. Further, it would be inconvenient to provide a separate image, which fits each screen display device based on individual device information.

### SUMMARY OF THE INVENTION

The present invention has been made to address at least the above problems and/or disadvantages and to provide at least the advantages described below. Accordingly, an aspect of the present invention provides a method and apparatus capable of flexibly expressing various effects without providing separate images every time the theme or screen resolution is changed, by constituting a splash screen according to editable splash screen information.

In accordance with an aspect of the present invention, a method is provided for displaying a splash screen in a screen display apparatus. It is determined whether editable splash screen information corresponding to an application program is stored in the screen display apparatus, when a command to execute the application program is received at the screen display apparatus. The splash screen is configured according to the editable splash screen information when the editable splash screen information is stored in the screen display apparatus. The splash screen configured by the editable splash screen information is displayed on the screen display apparatus.

In accordance with another aspect of the present invention, a screen display apparatus is provided. The screen display apparatus includes a display unit that displays a splash screen, an input unit that receives a command to execute an application program from a user, and a storage unit that stores the application program and splash screen information. The screen display apparatus also includes a controller that determines whether editable splash screen information corresponding to the application program is stored in the storage unit when the command to execute the application program is received, and, when the editable splash screen information is stored in the storage unit, configures the splash screen according to the editable splash screen information and controls the display to display the splash screen configured by the editable splash screen information.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating processing progress when a splash screen is not displayed;

FIG. 2A is a diagram illustrating processing progress that directly displays a splash screen in an application program;

FIG. 2B is a diagram illustrating a processing progress that displays a splash screen using a separate module;

FIG. 3 is a block diagram illustrating an apparatus for displaying a splash screen, according to an embodiment of the present invention;

FIG. 4 is a flowchart illustrating a splash screen display methodology, according to an embodiment of the present invention;

FIG. 5 is a flowchart illustrating splash screen information execution methodology, according to an embodiment of the present invention;

FIG. 6 illustrates a script, according to an embodiment of the present invention;

FIG. 7 illustrates a splash screen, according to an embodiment of the present invention;

FIG. 8 illustrates a splash screen, according to another embodiment of the present invention; and

FIG. 9 illustrates a splash screen, according to a further embodiment of the present invention.

### DETAILED DESCRIPTION OF EMBODIMENTS OF THE PRESENT INVENTION

Embodiments of the present invention are described in detail with reference to the accompanying drawings. The same or similar components are designed by the same or similar reference numerals although they are illustrated in different drawings. Detailed descriptions of constructions or processes known in the art may be omitted to avoid obscuring the subject matter of the present invention.

In embodiments of the present invention, the term “splash screen” refers to a screen that is shown to a user at the start point of an application program. In embodiments of the present invention, the splash screen is not limited to an image related to an application, but includes all visual information which can be recognized by user, such as, for example, a fake image, a moving picture, a flash or an animation.

In embodiments of the present invention, the term “editable splash screen information” is information that is required to constitute a splash screen, and is a programmed object. Some examples of the editable splash screen information include a script, a library, a library block and a set of changeable commands including a program code.

In embodiments of the present invention, the term “apparatus information” refers to information related to hardware performance of a screen display apparatus, and includes, for example, a resolution of the screen display apparatus and a processing speed of the CPU.

In embodiments of the present invention, the term “splash image” refers to a general image, which is used in the existing splash screen and cannot be edited.

In embodiments of the present invention, execution of an application program includes the reception of a user's execution request, the launching of the application program, and the displaying of the initial screen of the application program. Here, “launching” of an application includes calling the application from a storage unit and loading the program in the memory so that the user can use the application program.

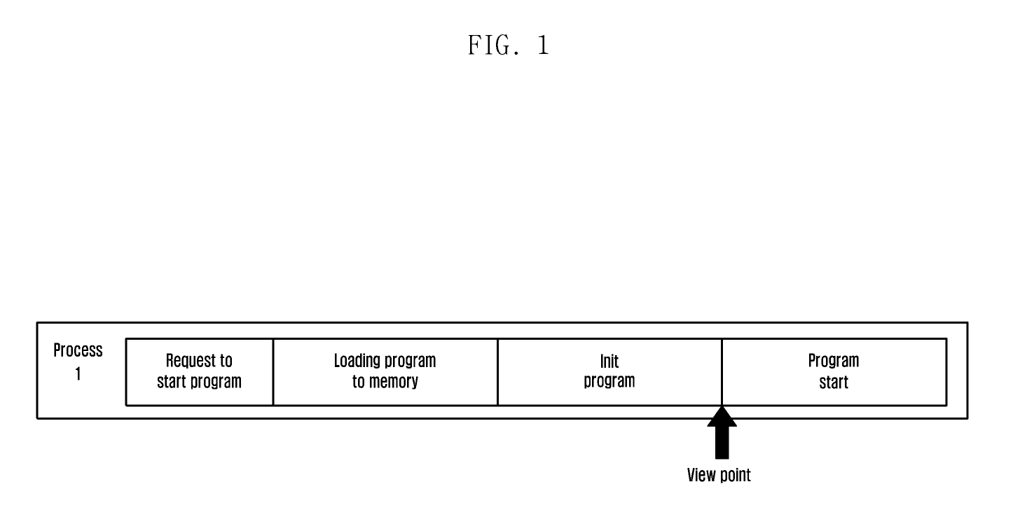

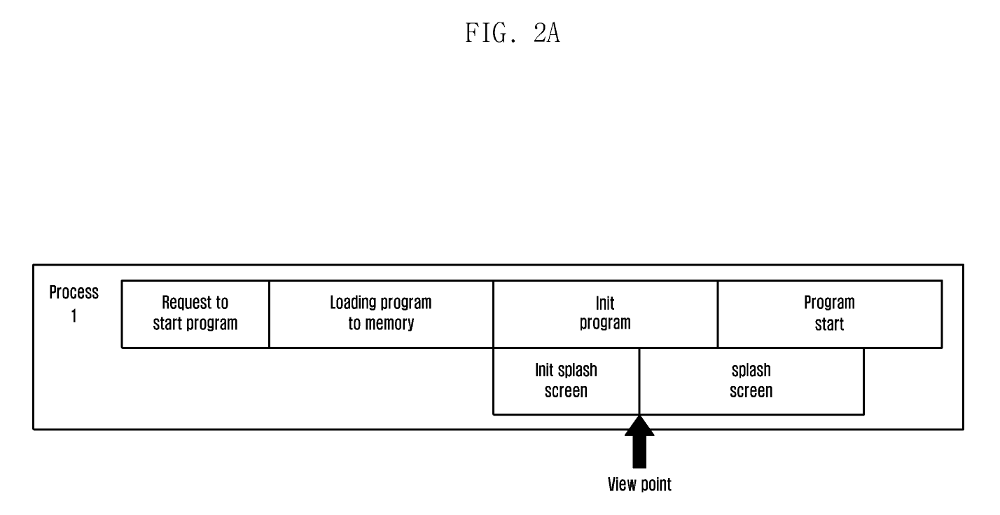

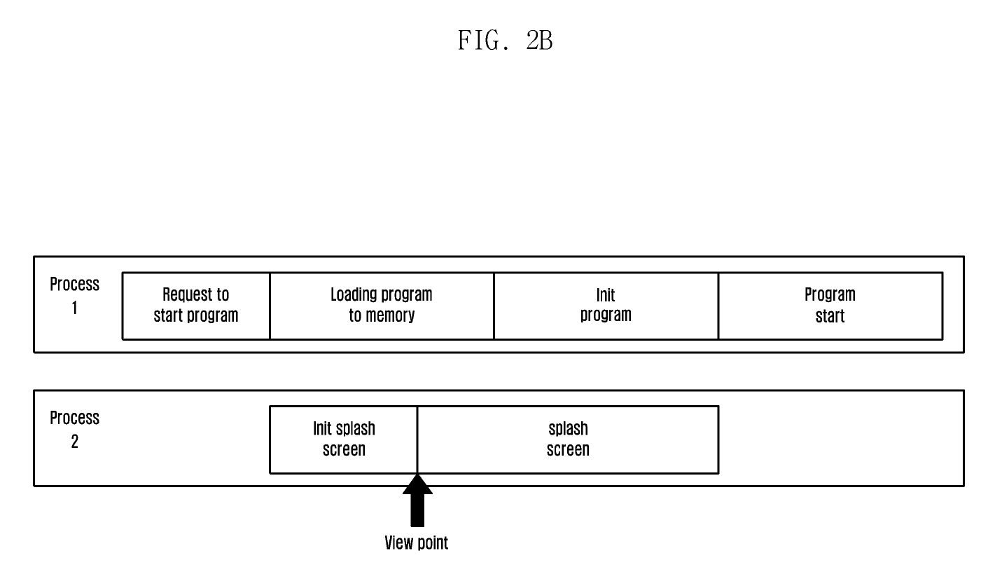

There are several methods for displaying a splash screen. FIG. 1 is a diagram illustrating processing progress when a splash screen is not used. In comparison therewith, FIGS. 2A and 2B are diagrams illustrating a splash screen processing progress.

Referring to FIG. 1, when a splash screen is not used, if user requests execution of a program, the apparatus executes the program. In executing the program, the program is started if the program is first loaded to the memory, the loading is completed, the program is initialized, and the initialization of the program is completed.

The program-related screen becomes visible to user at a time-point after the initialization of the program is completed. Therefore, a black screen may be displayed or an existing screen is displayed during the loading and initialization process of the program.

Therefore, the user is required to wait without any response until the initialization of the program is completed. Thus, the user cannot know whether the program is being appropriately executed and grow impatient waiting for a response.

Referring to FIG. 2A, when the user requests execution of a program, the apparatus executes the program. In executing the program, the program is first loaded to the memory. When the loading to the memory is completed, the initialization of the program is executed, and at the same time, the splash screen is initialized.

The initialization of the splash screen is usually completed earlier than the initialization of the program. If the initialization of the splash screen is completed, the splash screen is displayed. The splash screen is usually displayed until the program is started after the initialization of the program is completed. However, as illustrated in FIG. 2, it is possible for the splash screen to be displayed for a certain period of time even after the program is started and the initialization of the program is completed.

The user can receive a response from the execution-requested program before the initialization of the program is completed if the initialization of the splash screen is completed. Thus, the user response is better than those cases in which a splash screen is not used.

If the program is started or a certain period of time passes after the start of the program, the display of the splash screen is discontinued, and the program is executed.

Referring to FIG. 2B, a splash screen is displayed using a separate module. When the user requests execution of a program, the apparatus executes the program. When the program is executed, the program is loaded to the memory, and at the same time, the splash screen is initialized. Because the application program processing step and the splash screen display processing step are performed as separate processes, the splash screen can be initialized before the loading of the program to the memory is completed.

When the initialization of the splash screen is completed, the splash screen is displayed regardless of the program loading process. The splash screen is continually displayed during the program loading process and the program initialization process, indicating that the program is being executed.

Even before the program loading is completed, the user can receive a response from the execution-requested program if the initialization of the splash screen is terminated. Hence, user response is better than the cases in which a splash screen is not used or the application program directly handles the process of displaying the splash screen.

If the program is started or a certain period of time passes after the start of the program, the display of the splash screen is discontinued and the program is executed.

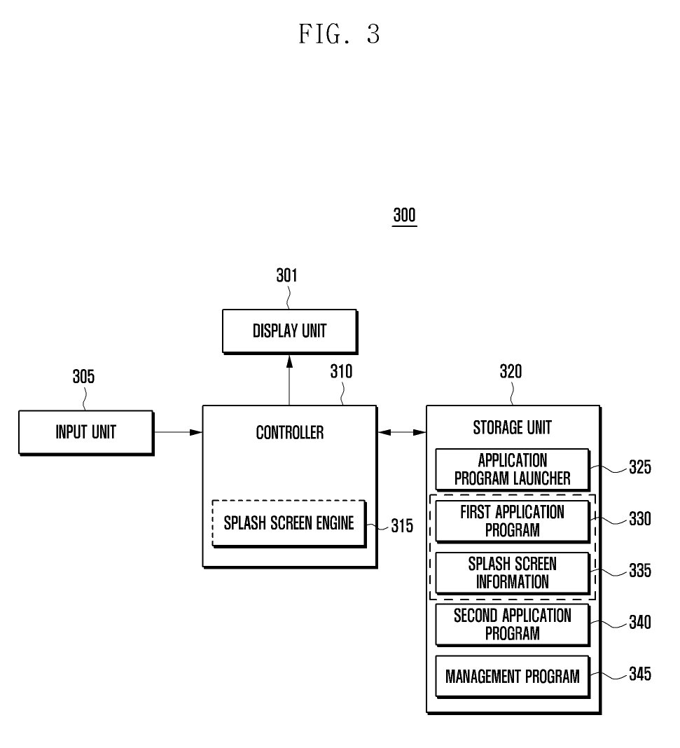

FIG. 3 is a block diagram illustrating an apparatus for displaying a splash screen, according to an embodiment of the present invention.

Referring to FIG. 3, an apparatus 300 for displaying a splash screen, according to an embodiment of the present invention, includes a display unit 301, an input unit 305, a controller 310 and a storage unit 320.

The display unit 301 can be embodied as a Liquid Crystal Display (LCD), an Organic Light Emitting Diode (OLED), or an Active Matrix Organic Light Emitting Diode (AMOLED). In an embodiment of the present invention, the display unit 301 provides a splash screen outputted from the controller 310 in the form of a visual signal that can be recognized by the user. Further, if the program is started, the screen of program execution is provided in the form of a visual signal that can be recognized by the user.

The input unit 305 allows the user to input key manipulation for controlling the splash screen display apparatus 300. The input unit 305 generates an input signal, and transmits the input signal to the controller 310. The input unit 305 can be embodied as a keypad including number keys, letter keys and direction keys, such as, for example, a 3×4 pad and a QWERTY pad, and can also be embodied as a touch panel. Further, the input unit 305 can be embodied as a button key, a jog key and a wheel key. In an embodiment of the present invention, a command is input from the user to the input unit 305 to execute the program, and the command is transmitted to the controller 310.

The storage unit 320 stores data and a program that is required to operate the splash screen display apparatus 300. The storage unit can be divided into a program area and a data area. The program area can store a program for controlling the general operation of the splash screen display apparatus 300, and other necessary application programs. The data area is an area for storing data generated according to the user of the splash screen display apparatus 300. The data area can store an image, video data and audio data, for example.

The storage unit 320 can be embodied as a volatile storage medium or a nonvolatile storage medium, and can also be embodied as the combination of both types of storage media. An example of a volatile storage medium is a semiconductor memory such as a Random Access Memory (RAM), a Dynamic Random Access Memory (DRAM) and a Static Random Access Memory (SRAM). Examples of a nonvolatile storage medium include a hard disk drive and a NAND-type flash memory.

The storage unit 320, according to an embodiment of the present invention, stores an application program launcher 325, a first application program 330, splash screen information 335, a second application program 340, and a window management program 345. The splash screen information 335 is editable splash screen information corresponding to the first application program.

The controller 310 controls the general operation of each component of the splash screen display apparatus 300. The controller 310, according to an embodiment of the present invention, receives the user's command to execute an application program through the input unit 305. When the controller 310 receives user's command to execute the application program, the controller 310 determines whether to store editable splash screen information corresponding to the executed application program.

In embodiments of the present invention, the term “editable splash screen information” is information that is required to constitute a splash screen, and is a programmed object. Examples of the editable splash screen information include a script, a library, a library block and a set of changeable commands including a program code.

In embodiments of the present invention, the term “splash image” refers to a general image that is used in the existing splash screen and cannot be edited.

When the controller 310 determines that editable splash screen information is stored in the application program that is being executed (the first application program 330), the controller 310 configures a splash screen according to the splash screen information 335. When the configuration of the splash screen is completed, the controller 310 controls the display unit 310 to display the configured splash screen.

When the controller 310 determines that the editable splash screen information is not stored in the application program, which has received an execution command, (second application program 340), the controller 310 determines whether a splash image is stored. When the controller 310 determines that the splash image is stored, the controller 310 controls the display unit 301 to display the splash image in the splash screen.

When the controller 310 determines that the splash image is not stored, the controller 310 awaits completion of the launching of the application program, before controlling the display unit 301 to display the initial screen of the application program.

The controller 310 determines whether the launching of an application executed by the user has been completed while the splash screen is being displayed. If the controller 310 determines that the launching of the application program executed by user has been completed, the controller 310 stops displaying the splash screen, and controls the display unit 301 to display the initial screen of the application program. When the controller 310 determines that the launching of the application executed by user has not been completed, the controller 310 controls the display unit 301 to continue to display the splash screen.

A splash screen engine 315 configures a splash screen according to the editable splash screen information. When the controller 310 determines that there is editable splash screen information in the application program being executed (the first application program 330), the splash screen engine 315 configures the splash screen according to splash screen information 335.

The splash screen engine 315 loads the splash screen information 335 corresponding to the application program (application program A). When the loading of splash screen information is completed, the splash screen engine 315 parses the splash screen information.

When the parsing of the splash screen information is completed, the splash screen engine 315 configures a splash screen using external resources, such as a memory. The splash screen engine 315 transmits a configured splash screen to the management program 345, displays the splash screen in the display unit 301.

In embodiments of the present invention, the term “apparatus information” refers to information related to hardware performance of a screen display apparatus, and includes a resolution of the screen display apparatus and a processing speed of the CPU, for example.

When configuring a splash screen, the splash screen engine 315 configures the splash screen according to apparatus information of the screen display apparatus 300. Therefore, the splash screen can be flexibly provided because it is not necessary for a different image to be provided every time the theme or screen resolution is changed.

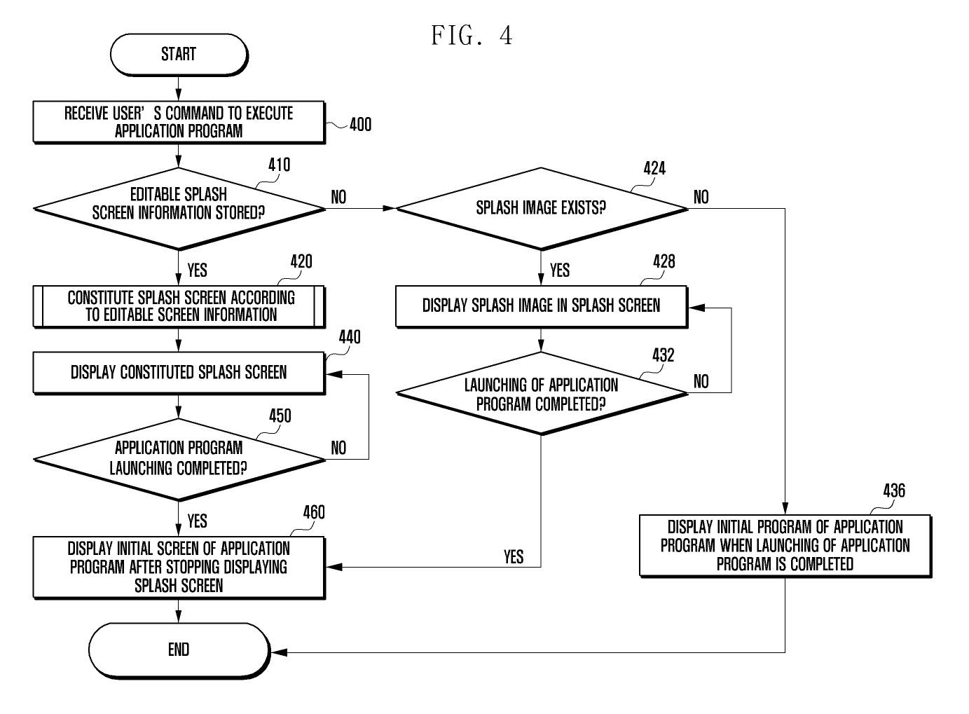

FIG. 4 is a flowchart illustrating a splash screen display methodology, according to an embodiment of the present invention.

The controller 310 of the screen display apparatus 300 receives the user's command to execute an application program through the input unit 305, in step 400. The controller 310 determines whether there is editable splash screen information for the application program being executed, in step 410.

When the controller 310 determines that there is editable splash screen information for the application program being executed (the first application program 330), the splash screen engine 315 configures a splash screen according to the splash screen information, in step 420.

When the splash screen has been configured, the controller 310 controls the display unit 301 to display the configured splash screen, in step 440. When the configured splash screen has been displayed, the controller 310 determines whether the application program executed by user has been launched, in step 450. When the controller 310 determines that the application program executed by user has been launched, the controller 310 controls the display unit 301 to stop displaying the splash screen and display the initial screen of the application program, in step 460.

When the controller 310 determines that the application program executed by user has not been launched, the controller 310 controls the display unit 310 to continue to display the splash screen, in step 440. When the controller 310 determines, in step 410, that editable splash screen information is not stored in the application program being executed, the controller 310 determines whether a stored splash screen exists, in step 424.

When the controller determines that the stored splash image exists, the controller controls the display unit 301 to display the splash image in the splash screen, in step 428.

When the splash screen is displayed, the controller 310 determines whether the application program executed by user has been launched, in step 432. When the controller 310 determines that the application program executed by user has been launched, the controller 310 controls the display unit 301 to stop displaying the splash screen and display the initial screen of the application program, in step 460.

When the controller 310 determines that the application program executed by user has not been launched, the controller 310 controls the display unit 301 to continue to display the splash screen, in step 428.

When the controller 310 determines, in step 424, that the stored splash image does not exist, the controller 310 displays the initial screen of the application program when the application program has launched, in step 436.

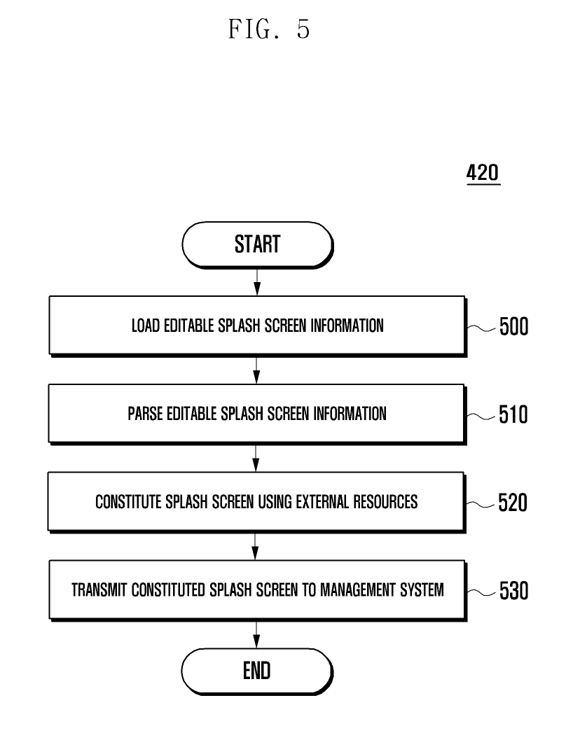

FIG. 5 is a flowchart illustrating a splash screen information execution methodology, according to an embodiment of the present invention.

When the controller 310 determines that there is splash screen information in the application program being executed, in step 410 of FIG. 4 (the first application program 330), the splash screen engine 315 configures the splash screen according to splash screen information 335, in step 420.

In embodiments of the present invention, the term “editable splash screen information” is information that is required to configure a splash screen, and is a programmed object. Examples of the editable splash screen information include a script, a library, a library block and a set of changeable commands including a program code.

When the controller determines that there is editable splash screen information, the splash screen engine 315 loads the splash screen information corresponding to the application program 330, in step 500. The splash screen engine 315 parses the splash screen information, in step 510.

The splash screen engine 315 configures the splash screen using external resources, such as a memory, in step 520. The splash screen engine 315 transmits the splash screen to the management system 345 and displays the splash screen in the display unit 301, in step 530.

In embodiments of the present invention, the term “apparatus information” refers to information related to hardware performance of a screen display apparatus, and includes the resolution of the screen display apparatus and the processing speed of the CPU.

The splash screen engine 315 configures a splash screen according to apparatus information of the screen display apparatus 300. Therefore, a splash screen can be flexibly provided without providing a separate image every time the screen resolution is changed.

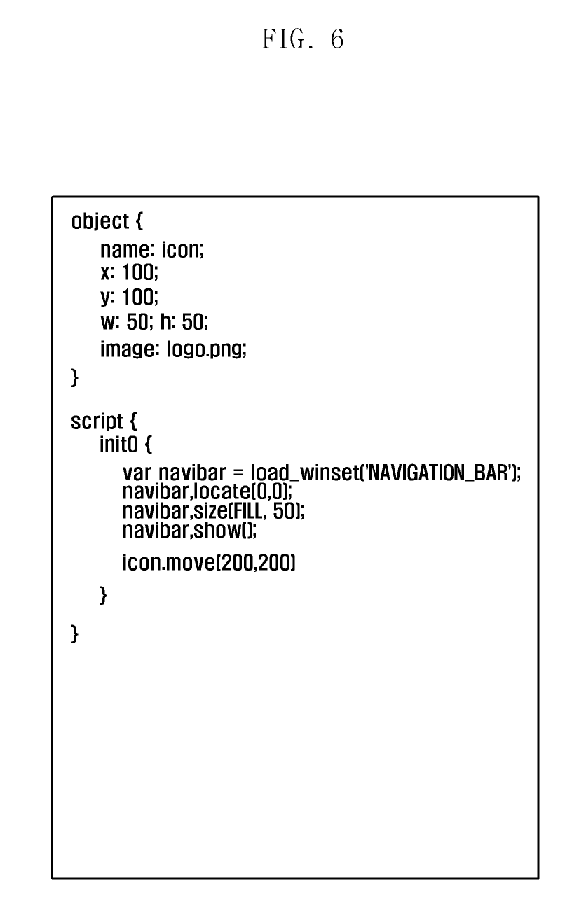

FIG. 6 illustrates a script, according to an embodiment of the present invention.

An object is defined in the script. The position of an object named “icon” is determined using x-axis coordinates (x: 100) and y-axis coordinates (y: 100). Further, the size of the object “icon” is determined by the width (w: 50) and the height (h: 50). The image to be expressed in the display unit 301 is also designated (image: logo.png).

The configuration of the splash screen is defined in the script. The script can be configured using Winset predefined in the platform, such as, for example, Winset “NAVIGATION_BAR” (var navibar=load_winset ['NAVIGATION BAR]). The position and size of the navigation bar are defined in the script (navibar,locate[0,0], navibar,size[FILL,50}). Further, a command to display the navigation bar in the display unit 301 is also included in the script (navibar, show[]). Further, a command to move the “icon” is also included in the script (icon.move[200,200]).

When the splash screen is configured using the editable splash screen information, a predefined image is not simply displayed, but the splash screen is configured according to programmed contents. Hence, the splash screen can be flexibly provided without providing a separate image based on a change of the theme or a change of the screen resolution.

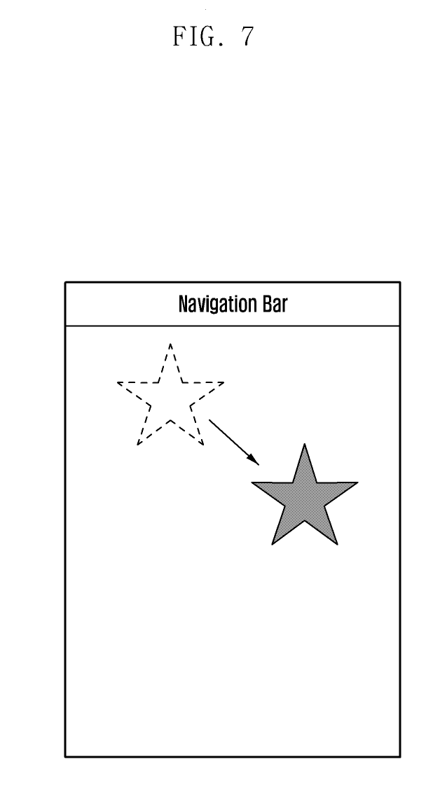

FIG. 7 illustrates a splash screen, according to an embodiment of the present invention.

Referring to the “Navigation Bar” of FIG. 7, the effects defined in the script of FIG. 6 are shown in the position and size shown in FIG. 7. Specifically, when the coordinates of the upper left corner of the screen are set to (0, 0), the “Navigation Bar” is positioned at the upper left side of the screen. Here, the horizontal line is filled up by setting width to “FILL” and the vertical line has the size of 50.

Regarding the star shape of FIG. 7, the defined effects of FIG. 6 are shown in the position and size shown in FIG. 7. Specifically, the star shape is initially positioned at (100, 100) with a width of 50 and a height of 50. Thereafter, the star shape moves to the position (200, 200).

As described above, for the splash screen configured using splash screen information like the script of an embodiment of the present invention, the splash screen is configured according to the program. Therefore, it is not necessary for a separate image to be provided as the resolution or the theme of the display unit 301 is changed.

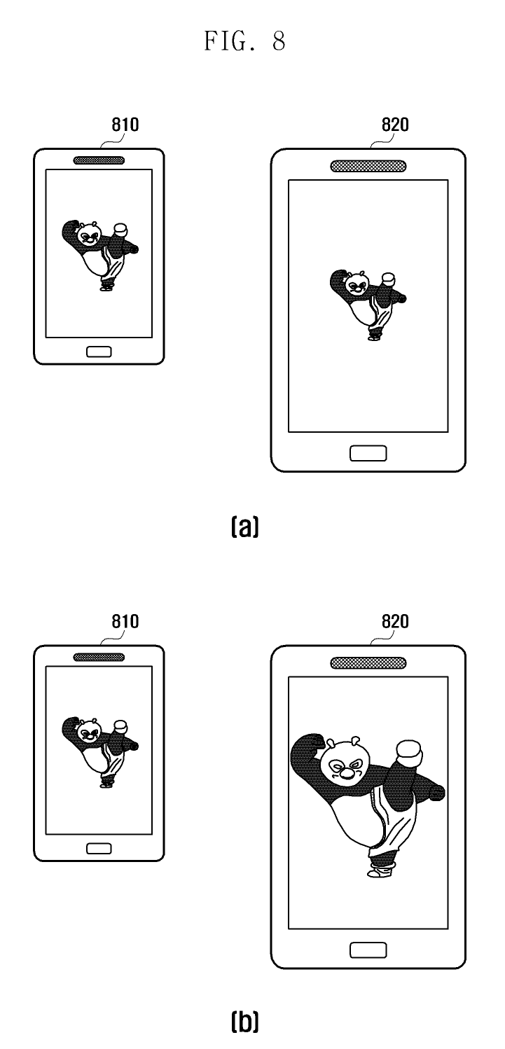

FIG. 8 illustrates a splash screen, according to another embodiment of the present invention.

As described above, when a splash screen is configured using splash screen information, the splash screen is configured according to apparatus information. Therefore, the splash screen can be flexibly provided without separately providing a separate image every time when the theme is changed or screen resolution is changed.

FIG. 8 illustrates splash screen configuration according to apparatus information using editable splash screen information.

The size of a display screen of a first screen display apparatus 810 is different from that of a second screen display apparatus 820, and thus their resolutions are also different. For example, if the resolution of the first screen display apparatus 810 is 800 x 600 and the resolution of the second screen display apparatus 820 is 1600 x 900, a general image is displayed as shown in FIG. 8A.

Specifically, the screen of the second screen display apparatus 820 is larger than that of the first screen display apparatus 810, but because the images are displayed in the same size, a larger amount of blank space is shown on the bottom side of the screen of the second screen display apparatus 820.

When a screen is displayed using editable splash screen information, the screen is shown as in FIG. 8B. Specifically, the displayed image becomes larger according to the resolution of the second screen display apparatus 820, and the image is displayed without the larger amount of blank space.

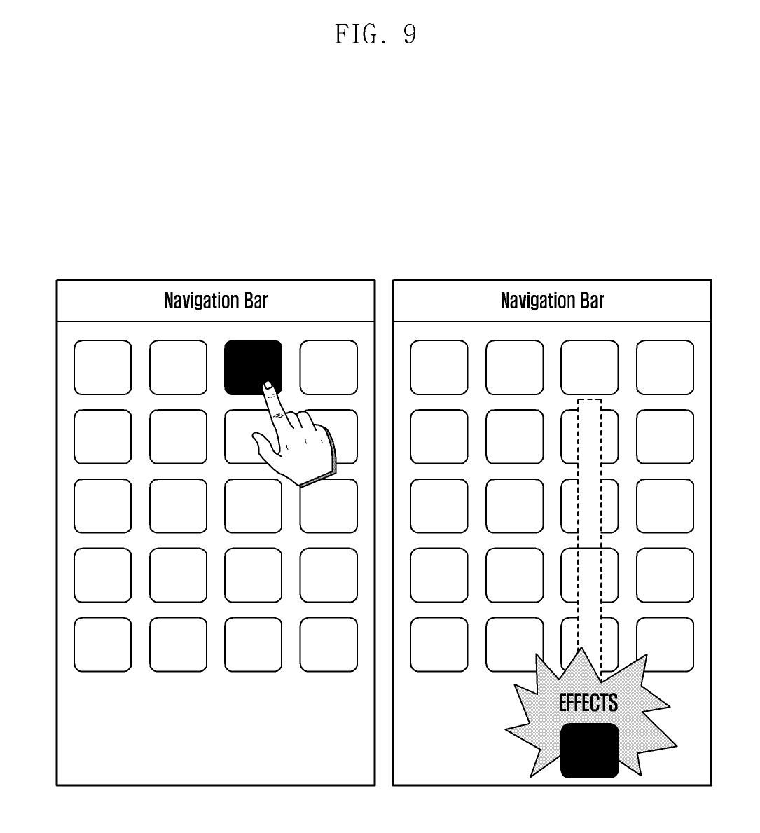

FIG. 9 illustrates a splash screen, according to a further embodiment of the present invention.

As described above, when a splash screen is configured using splash screen information, the splash screen is configured according to the program, and thus various effects, and not just a simple image, can be expressed. Specifically, a splash screen that includes various effects can be provided by providing a variously applicable splash screen.

FIG. 9 illustrates a splash screen that can express various effects using editable splash screen information.

When the user selects an application program to be executed in an application launcher 325 (the first application program 330), the application launcher 325 transmits the icon, icon location information and splash screen information 335 to the splash screen engine 315.

The splash screen engine 315 controls the display unit 301 to display a splash screen that is configured using the splash screen information 335 without directly displaying the log or image of the program. Specifically, when executing an application program, an effect that an icon falls down is expressed, and when the icon falls down, another screen is displayed, or when the initialization of the program is completed, the program is executed. The user can expect a prompt response according to program execution using such effects.

Further, a splash screen including various effects can be quickly provided by providing a variously applicable splash screen, and not a single simple screen.

According to embodiments of the present invention, a splash screen can be flexibly provided without providing separate images every time the theme or the screen resolution is changed. Further, a splash screen including various effects can be provided by providing a variously applicable splash screen.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for displaying a splash screen in a screen display apparatus, the method comprising the steps of:
determining whether editable splash screen information corresponding to an application program is stored when receiving a command to execute the application pro gram;
configuring the splash screen according to the editable splash screen information when the editable splash screen information is stored; and
displaying the splash screen configured by the editable splash screen information.

2. The method of claim 1, wherein displaying the splash screen comprises:
determining whether the application program has launched; and
when the application program has launched, ceasing display of the splash screen and displaying an initial screen of the application program.

3. The method of claim 1, wherein configuring the splash screen comprises:
loading the editable splash screen information;
parsing the editable splash screen information; and
configuring the splash screen using the parsed editable splash screen information.

4. The method of claim 3, wherein the splash screen is configured according to apparatus information of the screen display apparatus.

5. The method of claim 1, wherein the editable splash screen information comprises at least one of a script and a library.

6. The method of claim 1, wherein determining whether the editable splash screen information is stored comprises:
determining whether a splash image is stored when the editable splash screen information is not stored; and
displaying the stored splash image in the splash screen when the splash image is stored.

7. A screen display apparatus comprising:
a display unit that displays a splash screen;
an input unit that receives a command to execute an application program from a user;
a storage unit that stores the application program and splash screen information; and
a controller that determines whether editable splash screen information corresponding to the application program is stored in the storage unit when the command to execute the application program is received, and, when the editable splash screen information is stored in the storage unit, configures the splash screen according to the editable splash screen information and controls the display to display the splash screen configured by the editable splash screen information.

8. The apparatus of claim 7, wherein, after displaying the splash screen, the controller determines whether the application program has launched, and, when the application program has launched, controls the display to cease display of the splash screen and execute the application program.

9. The apparatus of claim 7, wherein the controller comprises a splash screen engine that loads the editable splash screen information, parses the editable splash screen information, and configures the splash screen using the parsed editable splash screen information.

10. The apparatus of claim 9, wherein the controller configures splash screen according to apparatus information of the screen display apparatus.

11. The apparatus of claim 7, wherein the editable splash screen information comprises at least one of a script and a library.

12. The apparatus of claim 7, wherein the controller determines whether a splash image is stored in the storage unit when the editable splash screen information is not stored, and controls the display unit to display the stored splash image in the splash screen when the splash image is stored in the storage unit.
